(19) United States
(12) Patent Application Publication
(10) Pub. No.: US 2010/0232537 A1
(43) Pub. Date: Sep. 16, 2010

(54) APPARATUS FOR TRANSMISSION THROUGH MULTIPLE ANTENNAS

(75) Inventors: Kung-min PARK, Goyang-si (KR); Sung-jin Suh, Seoul (KR); Sung-jun Yoon, Seoul (KR); Myung-cheul Jung, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/724,038

(22) Filed: Mar. 15, 2010

Related U.S. Application Data
(60) Provisional application No. 61/160,807, filed on Mar. 17, 2009.

(30) Foreign Application Priority Data
Mar. 16, 2009 (KR) 10-2009-22357

(51) Int. Cl. H04B 7/10; H04L 27/00; H04B 15/00

(52) U.S. Cl. 375/267; 375/295; 375/316; 375/347; 375/296

(57) ABSTRACT

A space-time coding apparatus receives two groups of inputs and outputs two groups of outputs. A configuration of each output group is based on spatial diversity and a configuration between the groups of outputs is based on spatial multiplexing. The space-time coding apparatus may include two spatial diversity coders whose outputs are each connected two spatial multiplexing coders. A plurality of antennas may be respectively connected to outputs of each spatial multiplexing coder. Coding coefficients are configured so that a first wireless receiving terminal corresponding to a first group of outputs receives only input signal components of a first group of inputs, and a second wireless receiving terminal corresponding to a second group of outputs receives only input signal components of a second group of inputs.

### CROSS-REFERENCE TO RELATED APPLICATIONS

This application claims priority from and the benefit of Korean Patent Application No. 10-2009-22357, filed on Mar. 16, 2009, and Provisional U.S. Application No. 61/160,807, filed on Mar. 17, 2009, which are both hereby incorporated by reference for all purposes as if fully set forth herein.

### BACKGROUND

1. Field of the Invention

Embodiments of the present invention relate to wireless transmission through multiple antennas, and more particularly, to space-time coding technology to be applied to wireless transmission through multiple antennas. Embodiments of the presented invention also relate to a precoding scheme.

2. Discussion of the Background

To make more efficient use of a limited frequency band, Multiple-Input and Multiple-Output (MIMO) technology using multiple antennas has been developed. The MIMO technology incorporates space-time coding, precoding, or both. The space-time coding is signal pre-processing to transmit input signals in an overlapping fashion or to temporally and spatially divide and transmit input signals through multiple antennas. Precoding is also signal pre-processing to transmit input signals in an overlapping or phase adaptation fashion but it operates only in spatial domain.

In the MIMO technology, a spatial diversity scheme, which is a subset of space-time coding, transmits information through multiple antennas in an overlapping fashion, and a spatial multiplexing scheme expands channels by dividing and transmitting separate information through multiple antennas. The spatial multiplexing scheme is a subset of precoding or a subset of space-time coding.

The spatial diversity scheme is generally believed to improve transmission reliability but not enhance a data transfer rate in some environments, whereas the spatial multiplexing scheme is generally believed to increase a data transfer rate but not transmission reliability. It is generally understood that the spatial diversity scheme shows good performance in a time varying channel or open loop system, while the precoding scheme shows good performance in a slow fading channel or closed loop system. It is also generally understood that the spatial diversity scheme is not well-designed for a commercial communication system where more than four transmit antennas are used.

FIG. 1 shows an example of a 2×2 MIMO system.

Referring to FIG. 1, a 2×2 MIMO system is a wireless transmission system with two transmission antennas and two reception antennas. Signals transmitted wirelessly at time t are designated y₀(t) and y₁(t), signals transmitted wirelessly at time t+T are designated y₀(t+T) and y₁(t+T), signals received wirelessly at time t are designated r₀(t) and r₁(t), and signals received wirelessly at time t+T are designated r₀(t+T) and r₁(t+T).

According to Space-Time Block Coding (STBC), which is a type of spatial diversity coding, when inputs of a wireless transmission terminal are x₀(i) and x₁(i), outputs of the wireless transmission terminal are coded as shown in Math figure 1.

$$[ \begin{matrix}{y}_{0} ( t ) \\ {y}_{1} ( t ) \\ {y}_{0} ( t + T ) \\ {y}_{1} ( t + T )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}_{0} ( i ) ) \\ Re ( {x}_{1} ( i ) ) \\ Im ( {x}_{0} ( i ) ) \\ Im ( {x}_{1} ( i ) )\end{matrix} ] \qquad [ Math figure 1 ]$$

In the case of a 4×4 MEMO system whose wireless transmission and reception terminals each have four antennas, the outputs of the wireless transmission terminal are coded in a more complicated fashion, as shown in Math figure 2.

$$[ \begin{matrix}{y}_{0} ( t ) \\ {y}_{1} ( t ) \\ {y}_{2} ( t ) \\ {y}_{3} ( t ) \\ {y}_{0} ( t + T ) \\ {y}_{1} ( t + T ) \\ {y}_{2} ( t + T ) \\ {y}_{3} ( t + T ) \\ {y}_{0} ( t + 2 T ) \\ {y}_{1} ( t + 2 T ) \\ {y}_{2} ( t + 2 T ) \\ {y}_{3} ( t + 2 T ) \\ {y}_{0} ( t + 3 T ) \\ {y}_{1} ( t + 3 T ) \\ {y}_{2} ( t + 3 T ) \\ {y}_{3} ( t + 3 T )\end{matrix} ] = \frac{1}{\sqrt{2}} [ \begin{matrix}1 & 0 & 0 & 0 & j & 0 & 0 & 0 \\ 0 & 0 & 0 & 0 & 0 & 0 & 0 & 0 \\ 0 & - 1 & 0 & 0 & 0 & j & 0 & 0 \\ 0 & 0 & 0 & 0 & 0 & 0 & 0 & 0 \\ 0 & 1 & 0 & 0 & 0 & j & 0 & 0 \\ 0 & 0 & 0 & 0 & 0 & 0 & 0 & 0 \\ 1 & 0 & 0 & 0 & - j & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 1 & 0 & 0 & 0 & j & 0 \\ 0 & 0 & 0 & 0 & 0 & 0 & 0 & 0 \\ 0 & 0 & 0 & - 1 & 0 & 0 & 0 & j \\ 0 & 0 & 0 & 0 & 0 & 0 & 0 & 0 \\ 0 & 0 & 0 & 1 & 0 & 0 & 0 & j \\ 0 & 0 & 0 & 0 & 0 & 0 & 0 & 0 \\ 0 & 0 & 1 & 0 & 0 & 0 & - j & 0\end{matrix} ] [ \begin{matrix}Re ( {x}_{0} ( i ) ) \\ Re ( {x}_{1} ( i ) ) \\ Re ( {x}_{2} ( i ) ) \\ Re ( {x}_{3} ( i ) ) \\ Im ( {x}_{0} ( i ) ) \\ Im ( {x}_{1} ( i ) ) \\ Im ( {x}_{2} ( i ) ) \\ Im ( {x}_{3} ( i ) )\end{matrix} ] \qquad [ Math figure 2 ]$$

However, in such a 4×4 MIMO system, the advantages of MIMO may not increase greatly relative to a 2×2 MIMO system despite the increased number of antennas.

### SUMMARY

Exemplary embodiments of the present invention provide a space-time coding apparatus or a hierarchical precoding apparatus, which may implement both transmission reliability and a data transfer rate.

Additional features of the invention will be set forth in the description which follows, and in part will be apparent from the description, or may be learned by practice of the invention.

An exemplary embodiment of the present invention discloses a space-time coding apparatus for wireless transmission, including: a first linear coder to code a first group of inputs and a second group of inputs into a first group of outputs, the first linear coder including coefficients configured so that a first wireless receiving terminal corresponding to the first group of outputs receives only input signal components of the first group of inputs; and a second linear coder to code the first group of inputs and the second group of inputs into a second group of outputs, the second linear coder including coefficients configured so that a second wireless receiving terminal corresponding to the second group of outputs receives only input signal components of the second group of inputs.

An exemplary embodiment of the present invention discloses a space-time coding apparatus for wireless coding. The apparatus includes a first spatial diversity coder to perform spatial diversity coding on a plurality of input signals, a second spatial diversity coder to perform spatial diversity coding on a plurality of input signals, a first spatial multiplexing coder to perform spatial multiplexing on outputs of the first spatial diversity coder, and a second spatial multiplexing coder to perform spatial multiplexing on outputs of the second spatial diversity coder.

An exemplary embodiment of the present invention discloses a space-time coding apparatus to receive two groups of inputs and to output two groups of outputs. Spatial diversity is implemented in each group of outputs, spatial multiplexing is implemented between the groups of outputs, and coding coefficients are configured so that a first wireless receiving terminal corresponding to a first group of outputs receives only input signal components of a first group of inputs, and a second wireless receiving terminal corresponding to a second group of outputs receives only input signal components of a second group of inputs.

An exemplary embodiment of the present invention discloses a multiple-input and multiple-output (MIMO) system, including a first antenna, a second antenna, and a hierarchical precoder. The hierarchical precoder includes a first precoder to perform spatial multiplexing by eigenvalue decomposition (EVD), a second precoder to perform spatial multiplexing by EVD, and a first interference canceller and a second interference canceller to perform partial interference cancellation on outputs of the first multiplexer and the second multiplexer.

An exemplary embodiment of the present invention discloses a space-time coding apparatus for wireless transmission. The space-time coding apparatus includes a plurality of antennas to radiate a signal on air, a precoder to procode the signal, and a spatial diversity coder included in front of the precoder. The spatial diversity coder performs spatial diversity on an input signal and the precoder performs an interference cancellation on an output of the spatial diversity coder.

An exemplary embodiment of the present invention discloses a transmitter for wireless transmission. The transmitter includes a plurality of antennas to radiate a signal on air and a first precoder and a second percoder to precode the signal. The second precoder is serially connected with the first precoder and performs an interference cancellation on an output of the first precoder.

An exemplary embodiment of the present invention discloses a wireless reception terminal. The wireless reception terminal includes a plurality of antennas to receive a plurality of signals from a transmitter on air, the plurality of signals including at least two subsets of the plurality of signals which may be obtained without interference or with reduced interference between two subsets due to the interference cancellation of the transmitter and a decoder to restore the received signals with the antennas.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an example of a 2×2 Multiple-Input and Multiple-Output (MIMO) system.

FIG. 2A is a diagram of a 4×4 MIMO system according to an exemplary embodiment.

FIG. 2B shows channel characteristic parameters of two groups in the 4×4 MIMO system.

FIG. 2C shows channel characteristic parameters reflecting interference between the two groups in the 4×4 MIMO system.

FIG. 3 is a block diagram of a space-time coding apparatus according to an exemplary embodiment.

FIG. 4 is a block diagram of a space-time coding apparatus according to an exemplary embodiment.

FIG. 5 shows exemplary input and output signals of spatial diversity coders included in the space-time coding apparatus.

FIG. 6 shows a hierarchical precoder according to an exemplary embodiment.

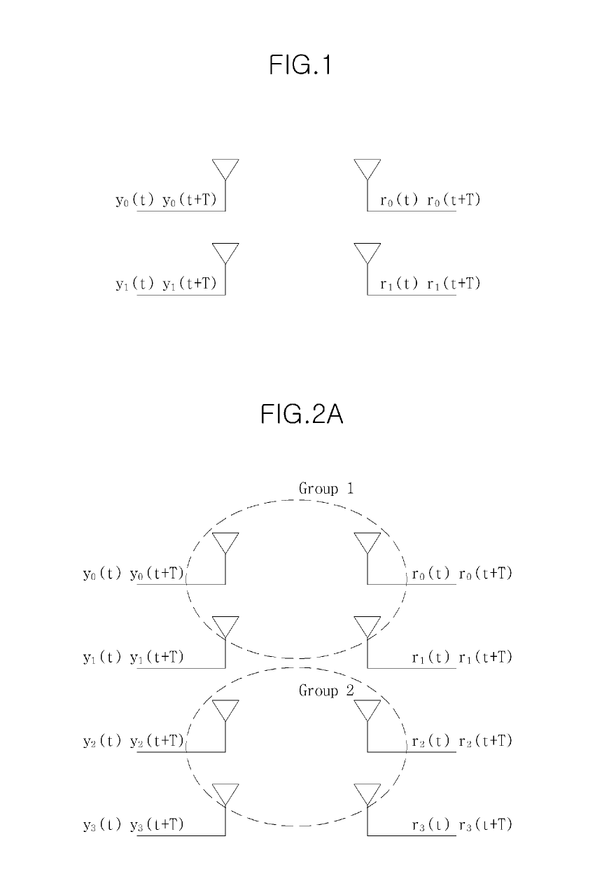

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

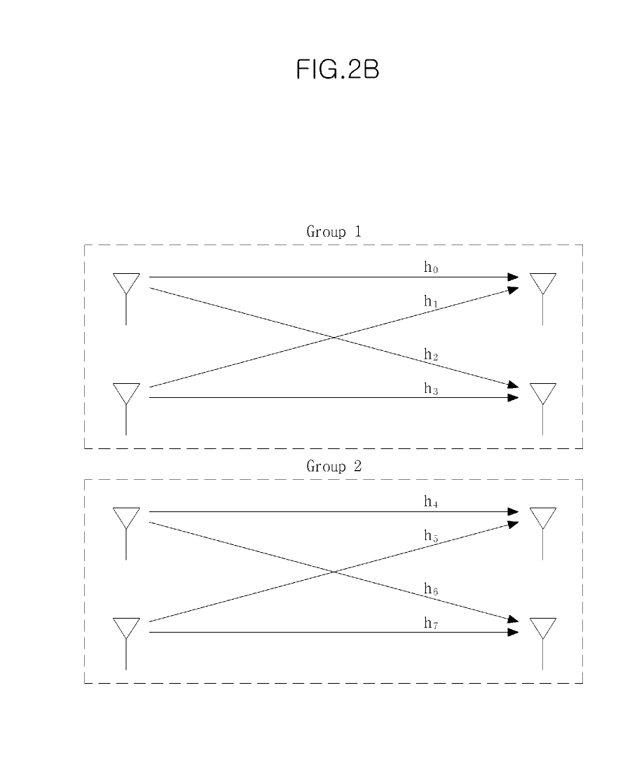

FIG. 2A is a diagram of a 4×4 Multiple-Input and Multiple-Output (MIMO) system according to an exemplary embodiment. Referring to FIG. 2A, the 4×4 MIMO system divides the four antennas of each terminal into two groups (a first output group Group 1 and a second output group Group 2). Then, the 4×4 MIMO system may apply spatial diversity coding and spatial multiplexing coding to the two groups while preventing or reducing interference between the two groups. Unlike in the conventional system, the 4×4 MIMO system may not apply only one of spatial diversity and spatial multiplexing to all four antennas of each transmission terminal and reception terminal.

FIG. 2B shows channel characteristic parameters of two groups in the 4×4 MIMO system. FIG. 2C shows channel characteristic parameters reflecting interference between the two groups in the 4×4 MIMO system. In FIG. 2B, h0 through h3 are channel characteristic parameters of the first output group, and h4 through h7 are channel characteristic parameters of the second output group. And in FIG. 2C, j0 through j3 are interference channel parameters of the second output group that affect the first output group, and j4 through j7 are interference channel parameters of the first output group that affect the second output group.

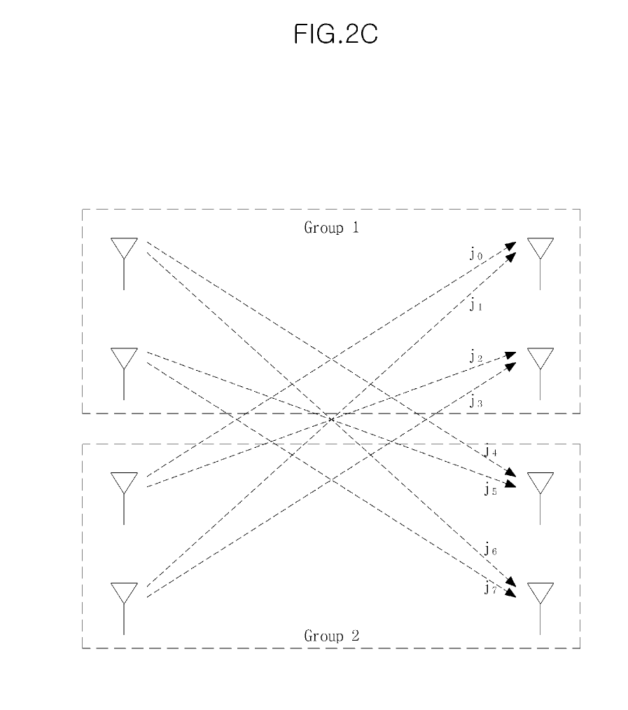

FIG. 3 is a block diagram of a space-time coding apparatus according to an exemplary embodiment.

Referring to FIG. 3, the space-time coding apparatus includes a first precoder 210 to code a plurality of groups of inputs into a first group of outputs. Further, the first precoder 210 includes coefficients configured so that a wireless receiving terminal corresponding to the first group of outputs receives only input signal components of a first group of inputs among the plurality of groups of inputs. The space-time coding apparatus also includes a second precoder 230 to code the plurality of groups of inputs into a second group of outputs. Further, the second precoder 230 includes coefficients configured so that a wireless receiving terminal corresponding to the second group of outputs receives only input signal components of a second group of inputs among the plurality of groups of inputs. Further, the second group of inputs is different from the first group of inputs.

As illustrated in FIG. 3, the space-time coding apparatus includes two groups of inputs and two groups of outputs, wherein spatial diversity is implemented in each group of outputs and spatial multiplexing is performed between the groups of outputs. Here, the two groups of inputs are (y₀(i), y₁(i)) and (y₂(i), y₃(i)). If the first precoder 210 and second precoder 230 are linear coders, the two groups of outputs may be expressed as (y₀(i)+c₀y₂(i)+c₁y₃(i), y₁(i)+c₂y₂(i)+c₃y₃(i)) and (y₂(i)+d₀y₀(i)+d₁y₁(i), y₃(i)+d₂y₀(i)+d₃y₁(i)), respectively.

Also, by connecting multiple antennas to the outputs of the first and second output groups, wireless transmission terminals may be configured.

In the current embodiment, the first precoder 210 and second precoder 230 may be configured so that signals received by wireless reception terminals each attain a spatial diversity gain and together attain a spatial multiplexing gain.

Due to a spatial multiplexing gain, there may be interference between the groups. Therefore, the first precoder 210 and the second precoder 230 are used to remove or reduce interference between the groups. In the current embodiment, interference I₀ and I₁ of an input (y₂(i), y₃(i)) of a lower group that may affect an upper group may be expressed as shown in Math figure 3.

I₀=(c₀h₀+c₂h₁+j₀)y₂(i)+(c₁h₀+c₃h₁+j₁)y₃(i)

I₁=(c₀h₂c₂h₃+j₂)y₂(i)+(c₁h₂+c₃h₃+j₃)y₃(i) [Math figure 3]

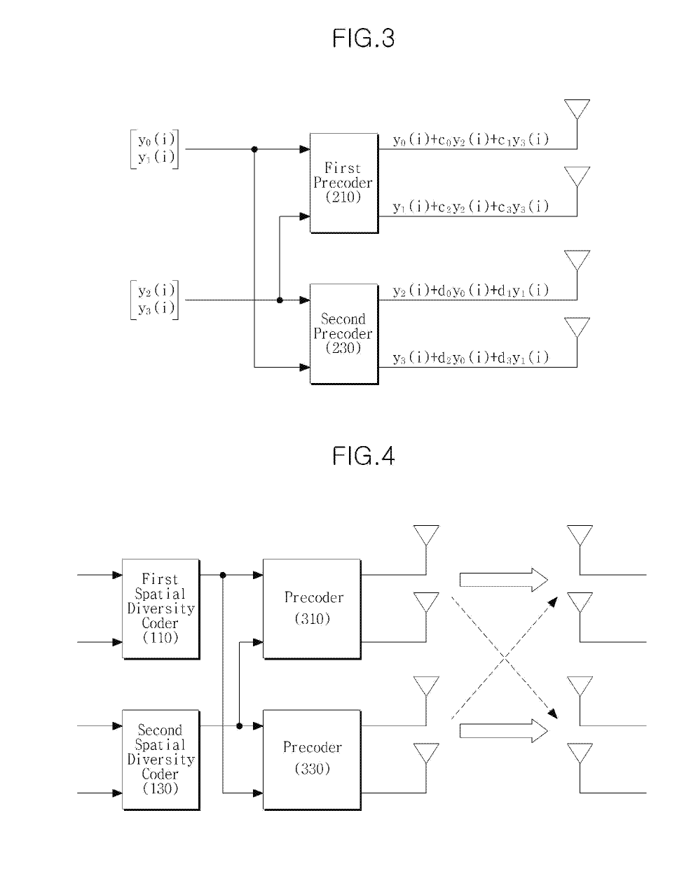

The interference I₀ and I₁ may be reduced or eliminated by defining coefficients Cₙ of the first precoder 210, which is a linear coder, as shown in Math figure 4.

$${c}_{0} = \frac{{h}_{3} {j}_{0} - {h}_{1} {j}_{2}}{{h}_{3} {h}_{0} - {h}_{1} {h}_{2}} {c}_{2} = \frac{{h}_{2} {j}_{0} - {h}_{0} {j}_{2}}{{h}_{1} {h}_{2} - {h}_{3} {h}_{0}} \\ {c}_{1} = \frac{{h}_{3} {j}_{1} - {h}_{1} {j}_{3}}{{h}_{3} {h}_{0} - {h}_{1} {h}_{2}} {c}_{3} = \frac{{h}_{2} {j}_{1} - {h}_{0} {j}_{3}}{{h}_{1} {h}_{2} - {h}_{3} {h}_{0}} \qquad [ Math figure 4 ]$$

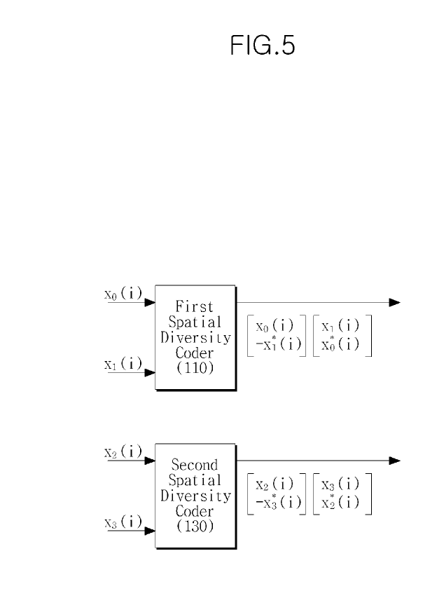

In the same way, interference I₂ and I₃ of an input (y₀(i), y₁(i)) of the first group that may affect the second group may be expressed as shown in Math FIG. 5.

I₂=(d₀h₄+d₂h₅+j₄)y₀(i)+(d₁h₄+d₃h₅+j₅)y₁(i)

I₃=(d₀h₆+d₂h₇j₆)y₀(i)+(d₁h₆+d₃h₇+j₇)y₁(i) [Math figure 5]

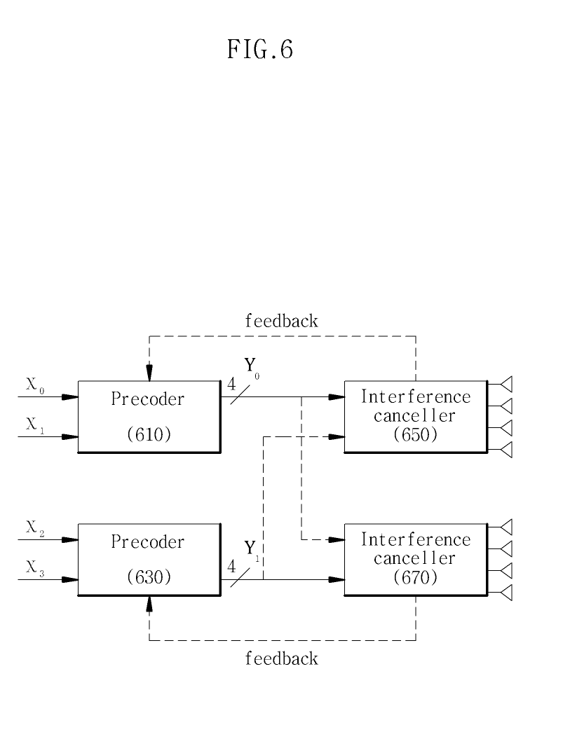

Here, the interference I₂ and I₃ may be reduced or eliminated by defining the coefficients dₙ of the second precoder 230, as shown in Math figure 6.

$${d}_{0} = \frac{{h}_{7} {j}_{4} - {h}_{5} {j}_{6}}{{h}_{7} {h}_{4} - {h}_{5} {h}_{6}} {d}_{2} = \frac{{h}_{6} {j}_{4} - {h}_{4} {j}_{6}}{{h}_{5} {h}_{6} - {h}_{7} {h}_{4}} \\ {d}_{1} = \frac{{h}_{3} {j}_{1} - {h}_{1} {j}_{3}}{{h}_{3} {h}_{0} - {h}_{1} {h}_{2}} {d}_{3} = \frac{{h}_{2} {j}_{1} - {h}_{0} {j}_{3}}{{h}_{1} {h}_{2} - {h}_{3} {h}_{0}} \qquad [ Math figure 6 ]$$

As a result, by coding of the first precoder 210 and second precoder 230, signals received by the wireless reception terminals may be obtained without interference or with reduced interference between the groups, as shown in Math figure 7.

r₀(i)=H₀y₀(i)+H₁y₁(i)+η₀

r₁(i)=H₂y₀(i)+H₃y₁(i)+η₁

r₂=H₄y₂(i)+H₅y₃(i)+η₂

r₃(i)=H₆y₂(i)+H₇y₃(i)+η₃, [Math figure 7]

where η is an added noise component. The coefficients Hₙ may be rewritten as shown in Math figure 8.

H₀=h₀+j₀d₀+j₁d₂ H₁=h₁+j₁d₁+j₁d₃

H₂=h₂+j₂d₀+j₃d₂ H₃=h₃+j₂d₁+j₃d₃

H₄=h₄+j₄c₀+j₅c₂ H₅=h₅+j₄c₂+j₅c₃

H₆=h₆+j₆c₀+j₇c₂ H₇=h₇+j₆c₁+j₇c₃ [Math figure 8]

That is, when each of the input and output groups includes of two signals and the first precoder 210 and second precoder 230 are implemented using the following coefficient vectors as shown in Math figure 9, interference between the groups may be reduced or eliminated, spatial diversity may be achieved in each group, and spatial multiplexing may be achieved between the groups.

$$[ \begin{matrix}1 & 0 & {c}_{0} & {c}_{1} \\ 0 & 1 & {c}_{2} & {c}_{3}\end{matrix} ] , [ \begin{matrix}{d}_{0} & {d}_{1} & 1 & 0 \\ {d}_{2} & {d}_{3} & 0 & 1\end{matrix} ] \qquad [ Math figure 9 ]$$

Coefficients of the first precoder 210 and second precoder 230 are given as shown in Math figure 10.

$${c}_{0} = \frac{{h}_{3} {j}_{0} - {h}_{1} {j}_{2}}{{h}_{3} {h}_{0} - {h}_{1} {h}_{2}} {c}_{2} = \frac{{h}_{2} {j}_{0} - {h}_{0} {j}_{2}}{{h}_{1} {h}_{2} - {h}_{3} {h}_{0}} \\ {c}_{1} = \frac{{h}_{3} {j}_{1} - {h}_{1} {j}_{3}}{{h}_{3} {h}_{0} - {h}_{1} {h}_{2}} {c}_{3} = \frac{{h}_{2} {j}_{1} - {h}_{0} {j}_{3}}{{h}_{1} {h}_{2} - {h}_{3} {h}_{0}} \\ {d}_{0} = \frac{{h}_{7} {j}_{4} - {h}_{5} {j}_{6}}{{h}_{7} {h}_{4} - {h}_{5} {h}_{6}} {d}_{2} = \frac{{h}_{6} {j}_{4} - {h}_{4} {j}_{6}}{{h}_{5} {h}_{6} - {h}_{7} {h}_{4}} \\ {d}_{1} = \frac{{h}_{3} {j}_{1} - {h}_{1} {j}_{3}}{{h}_{3} {h}_{0} - {h}_{1} {h}_{2}} {d}_{3} = \frac{{h}_{2} {j}_{1} - {h}_{0} {j}_{3}}{{h}_{1} {h}_{2} - {h}_{3} {h}_{0}} . \qquad [ Math figure 10 ]$$

As a result, in the current embodiment, the reception signals of the wireless reception terminal have the same format as signals subjected to space-time block coding (STBC), and accordingly may be restored by a STBC decoder or the like.

FIG. 4 is a block diagram of a space-time coding apparatus according to an exemplary embodiment. Referring to FIG. 4, the space-time coding apparatus includes first spatial diversity coder 110 and second spatial diversity coder 130 to perform spatial diversity coding on a plurality of input signals, a precoder 310 to perform spatial multiplexing on outputs of the first spatial diversity coder 110, and a precoder 330 to perform spatial multiplexing on outputs of the second spatial diversity coder 130. Also, a wireless transmission terminal may be configured by connecting multiple antennas to the outputs of the precoder 310 and precoder 330. The precoder 310 and the precoder 330 may have the same configurations as the first precoder 210 and the second precoder 230 illustrated in FIG. 3, respectively. As illustrated in FIG. 4, the spatial diversity coder 110 and spatial diversity coder 130 may be included in front of the precoder 310 and precoder 330. As can shown by the Math figure 10, precoder 310 and precoder 330 can mitigate inter-input group interference using channel state information.

Each of the precoder 310 and precoder 330 combines an output of the first spatial diversity coder 110 with an output of the second spatial diversity coder 130, and outputs the result of the combination. In more detail, the precoder 310 combines an output of the first spatial diversity coder 110 with an output of the second spatial diversity coder 130 to output a first output, and combines another output of the first spatial diversity coder 110 with an output of the second spatial diversity coder 130 to output a second output. That is, just as shown as outputs of the first precoder 210 and second precoder 230 in FIG. 3, the output groups of the precoder 310 and precoder 330 may be expressed as (y₀(i)+c₀y₂(i)+c₁y₃(i), y₁(i)+c₂y₂(i)+c₃y₃(i)) and (y₂(i)+d₀y₀(i)+d₁y₁(i), y₃(i)+d₂y₀(i)+d₃y₁(i)). Since operation of the first precoder 210 and second precoder 230 has been described above, a more detailed description of the precoder 310 and precoder 330 will be omitted.

FIG. 5 shows exemplary input and output signals of the first spatial diversity coder 110 and second spatial diversity coder 130 illustrated in FIG. 4. The first spatial diversity coder 110 and second spatial diversity coder 130 are space-time block coding (STBC) coders of a 2×2 MIMO. In the current embodiment, the first spatial diversity coder 110 and second spatial diversity coder 130 are each space-time coding blocks enabling signals transmitted by transmission terminals of corresponding groups to attain 2×2 spatial diversity gains.

FIG. 6 shows a hierarchical precoder including serially connected precoding stages according to an exemplary embodiment. The left side of precoders 610 and 630—referred to as LPs—perform spatial multiplexing by EVD (eigenvalue decomposition) or other schemes, and the right side of precoders 650 and 670—referred to as RPs—perform partial interference cancellation.

The LPs can be designed based on the channel statistics for each input group is passing through the precoders, or the design of the LP part could be independent of the channel statistics.

If LPs 610 and 630 are designed based on the channel statistics of Y₀ or Y₁ passing through, when the transmission of Y₀ or Y₁ is modified by RPs 650 and 670, the signal-to-interference plus noise ratio (SINR) gains by the LPs 610 and 630 may degrade, and in some cases, the degradation can be severe. To overcome the negative effect of RPs 650 and 670, RPs 650 and 670 inform the LPs 610 and 630 how the transmission of Y₀ or Y₁ is modified through feedback, and LPs 610 and 630 find the spatial multiplexing precoder which is optimum (or sub-optimum or adapted at least) to the modified transmission of Y₀ or Y₁. After that, RPs 650 and 670 perform interference cancelling again, and the iterative process continues until the overall SINR gain exceeds a predetermined threshold value. In other words, SINR gains of outputs of the first interference canceller 650 and the second interference canceller 670 are iteratively measured and reported to the first precoder 610 and the second precoder 630, and the first precoder 610 and the second precoder 630 adjust the spatial multiplexing until the outputs of the first interference canceller 650 and the second interference canceller 670 have an SINR gain that exceeds a predetermined threshold.

The first precoder 610 of RPs has a matrix including coefficients that are determined for a remote receiving terminal corresponding to the upper part 610 to receive only signal components corresponding to the inputs of the upper part itself. The second precoder 630 of RPs has a matrix including coefficients that are determined for a remote receiving terminal corresponding to the lower part 630 to receive only signal components corresponding to the inputs of the lower part itself.

As described above, an exemplary embodiment of the present invention discloses a wireless reception terminal. The wireless reception terminal includes a plurality of antennas to receive a plurality of signals from a transmitter on air where the plurality of signals includes at least two subsets of the plurality of signals which may be obtained without interference or with reduced interference between two subsets due to the interference cancellation of the transmitter and a decoder to restore the received signals with the antennas.

This application is further related to the U.S. Patent Application having attorney docket number P2922US00, which claims priority from and the benefit of Korean Patent Application No. 10-2009-0022358, filed on Mar. 16, 2009. Both of these applications, assigned to the assignee of the current application, are hereby incorporated by reference for all purposes as if fully set forth herein.

While the exemplary embodiments have been shown and described, it will be understood by those skilled in the art that various changes in form and details may be made thereto without departing from the spirit and scope of this disclosure as defined by the appended claims and their equivalents. Thus, as long as modifications fall within the scope of the appended claims and their equivalents, they should not be misconstrued as a departure from the scope of the invention itself.

What is claimed is:

1. A space-time coding apparatus for wireless transmission, comprising:
a first linear coder to code a first group of inputs and a second group of inputs into a first group of outputs, the first linear coder including coefficients configured so that a first wireless receiving terminal corresponding to the first group of outputs receives only input signal components of the first group of inputs; and
a second linear coder to code the first group of inputs and the second group of inputs into a second group of outputs, the second linear coder including coefficients configured so that a second wireless receiving terminal corresponding to the second group of outputs receives only input signal components of the second group of inputs.

2. The space-time coding apparatus of claim 1, wherein the first group of inputs are different from the second group of inputs.

3. The space-time coding apparatus of claim 2, wherein the first linear coder and the second linear coder are configured so that reception signals of the first wireless receiving terminal and the second wireless receiving terminal attain at least one of spatial diversity gains and spatial multiplexing gains.

4. The space-time coding apparatus of claim 3, further comprising:
a first spatial diversity coder to perform spatial diversity coding on the first group of inputs and the second group of inputs, and to supply the result of the coding to the first linear coder; and
a second spatial diversity coder to perform spatial diversity coding on the first group of inputs and the second group of inputs, and to supply the result of the coding to the second linear coder.

5. The space-time coding apparatus of claim 4, further comprising:
a plurality of antennas respectively connected to outputs of the first group of outputs; and
a plurality of antennas respectively connected to outputs of the second group of outputs.

6. The space-time coding apparatus of claim 3, wherein the first groups of inputs, the second groups of inputs, the first group of outputs, and the second groups of outputs each include two signals,
the first linear coder and the second linear coder include the following coefficients, respectively:
$$[ \begin{matrix}1 & 0 & {c}_{0} & {c}_{1} \\ 0 & 1 & {c}_{2} & {c}_{3}\end{matrix} ] , [ \begin{matrix}{d}_{0} & {d}_{1} & 1 & 0 \\ {d}_{2} & {d}_{3} & 0 & 1\end{matrix} ] , \\ wherein$$
$${c}_{0} = \frac{{h}_{3} {j}_{0} - {h}_{1} {j}_{2}}{{h}_{3} {h}_{0} - {h}_{1} {h}_{2}} {c}_{2} = \frac{{h}_{2} {j}_{0} - {h}_{0} {j}_{2}}{{h}_{1} {h}_{2} - {h}_{3} {h}_{0}}$$
$${c}_{1} = \frac{{h}_{3} {j}_{1} - {h}_{1} {j}_{3}}{{h}_{3} {h}_{0} - {h}_{1} {h}_{2}} {c}_{3} = \frac{{h}_{2} {j}_{1} - {h}_{0} {j}_{3}}{{h}_{1} {h}_{2} - {h}_{3} {h}_{0}}$$
$${d}_{0} = \frac{{h}_{7} {j}_{4} - {h}_{5} {j}_{6}}{{h}_{7} {h}_{4} - {h}_{5} {h}_{6}} {d}_{2} = \frac{{h}_{6} {j}_{4} - {h}_{4} {j}_{6}}{{h}_{5} {h}_{6} - {h}_{7} {h}_{4}}$$
$${d}_{1} = \frac{{h}_{3} {j}_{1} - {h}_{1} {j}_{3}}{{h}_{3} {h}_{0} - {h}_{1} {h}_{2}} {d}_{3} = \frac{{h}_{2} {j}_{1} - {h}_{0} {j}_{3}}{{h}_{1} {h}_{2} - {h}_{3} {h}_{0}} ,$$
and
wherein h0 through h3 are channel characteristic parameters of the first group of outputs, h4 through h7 are channel characteristic parameters of the second group of outputs, j0 through j3 are interference channel parameters of the second group of outputs that affect the first group of outputs, and j4 through j7 are interference channel parameters of the first group of outputs that to affect the second group of outputs.

7. The space-time coding apparatus of claim 6, further comprising:
a first spatial diversity coder to perform spatial diversity coding on a first set of two input signals and to supply the result of the coding to the first linear coder; and
a second spatial diversity coder to perform spatial diversity coding on a second set of two input signals and to supply the result of the coding to the second linear coder.

8. A space-time coding apparatus for wireless coding, comprising:
a first spatial diversity coder to perform spatial diversity coding on a plurality of input signals;
a second spatial diversity coder to perform spatial diversity coding on a plurality of input signals;
a first spatial multiplexing coder to perform spatial multiplexing on outputs of the first spatial diversity coder; and
a second spatial multiplexing coder to perform spatial multiplexing on outputs of the second spatial diversity coder.

9. The space-time coding apparatus of claim 8, wherein the first spatial multiplexing coder combines an output of the first spatial diversity coder with an output of the second spatial diversity coder to output a first output, and the second spatial multiplexing coder combines an output of the first spatial diversity coder with an output of the second spatial diversity coder to output a second output.

10. The space-time coding apparatus of claim 9, wherein the first spatial multiplexing coder combines a first output of the first spatial diversity coder with the output of the second spatial diversity coder to output a first output, and combines a second output of the first spatial diversity coder with the output of the second spatial diversity coder to output a second output.

11. The space-time coding apparatus of claim 8, further comprising a plurality of antennas to radiate the outputs of the first spatial multiplexing coder and the second spatial multiplexing coder.

12. A space-time coding apparatus to receive two groups of inputs and to output two groups of outputs, wherein spatial diversity is implemented in each group of outputs, spatial multiplexing is implemented between the groups of outputs, and coding coefficients are configured so that a first wireless receiving terminal corresponding to a first group of outputs receives only input signal components of a first group of inputs, and a second wireless receiving terminal corresponding to a second group of outputs receives only input signal components of a second group of inputs.

13. The space-time coding apparatus of claim 12, further comprising two spatial diversity coders, wherein an output of each spatial diversity coder is connected to one of the two groups of inputs.

14. The space-time coding apparatus of claim 12, wherein interference is prevented between the groups of outputs.

15. The space-time coding apparatus of claim 12, further comprising a plurality of antennas to radiate the two groups of outputs.

16. A multiple-input and multiple-output (MIMO) system, comprising:
a first antenna;
a second antenna; and
a hierarchical precoder,
wherein the hierarchical precoder comprises a first precoder to perform spatial multiplexing by eigenvalue decomposition (EVD), a second precoder to perform spatial multiplexing by EVD, and a first interference canceller and a second interference canceller to perform partial interference cancellation on outputs of the first multiplexer and the second multiplexer.

17. The MIMO system of claim 16, wherein signal-to-interference plus noise ratio (SINR) gains of outputs of the first interference canceller and the second interference canceller are iteratively measured and reported to the first precoder and the second precoder, respectively, and the first precoder and the second precoder adjust the spatial multiplexing until the outputs of the first interference canceller and the second interference canceller have an SINR gain that exceeds a predetermined threshold.

18. A space-time coding apparatus for wireless transmission, comprising:
a plurality of antennas to radiate a signal on air;
a precoder to procode the signal; and
a spatial diversity coder included in front of the precoder,
wherein the spatial diversity coder performs spatial diversity on an input signal and the precoder performs an interference cancellation on an output of the spatial diversity coder.

19. The space-time coding apparatus of claim 18, wherein the input signal comprises a first subset and a second subset of a plurality of signals, and the first subset is different from the second subset.

20. The space-time coding apparatus of claim 19, wherein the precoder performs the interference cancellation to cancel interference between the first subset and the second subset of the input signal.

21. The space-time coding apparatus of claim 20, wherein the spatial diversity coder comprises a first spatial diversity coder and a second spatial diversity coder, wherein the first spatial diversity coder performs spatial diversity on the first subset of the input signal, and the second spatial diversity coder performs spatial diversity on the second subset of input signal.

22. The space-time coding apparatus of claim 21, wherein the precoder comprises a first precoder and a second precoder, wherein the first precoder performs the interference cancellation on an output of the first spatial diversity coder, and the second precoder performs the interference cancellation on an output of the second spatial diversity coder.

23. A transmitter for wireless transmission, comprising:
a plurality of antennas to radiate a signal on air; and
a first precoder and a second precoder to precode the signal,
wherein the second precoder is serially connected with the first precoder and performs an interference cancellation on an output of the first precoder.

24. The transmitter of claim 23, wherein an input signal to the transmitter comprises a first subset and a second subset of a plurality of signals, and the first subset is different from the second subset.

25. The transmitter of claim 24, wherein the second precoder performs the interference cancellation to cancel interference between the first subset and the second subset of the input signal.

26. The transmitter of claim 25, wherein the second precoder comprises an upper side and a lower side, wherein the upper side performs the interference cancellation on an output of the first percoder for the first subset of the input signal and the lower side performs the interference cancellation on an output of the first precoder for the second subset of the input signal.

27. The transmitter of claim 23, wherein the first precoder precodes the input signal by a first matrix and the second precoder precodes the output of the first precoder by a second matrix, wherein the first matrix and the second matrix are combined into a single precoding matrix for the plurality of antennas.

28. A wireless reception terminal, comprising:
a plurality of antennas to receive a plurality of signals from a transmitter on air, the plurality of signals comprising two subsets of the plurality of signals which are obtained without interference or with reduced interference between the two subsets due to the interference cancellation of the transmitter; and
a decoder to restore the received signals with the antennas.
